(19) United States
(12) Patent Application Publication
(10) Pub. No.: US 2013/0252600 A1
(43) Pub. Date: Sep. 26, 2013

(54) METHOD AND APPARATUS FOR REMOTELY CONTROLLING MOBILE TERMINAL USING VIRTUAL KEYPAD

(71) Applicant: RSUPPORT CO., LTD., Seoul (KR)

(72) Inventor: Hyung Su SEO, Yangpyeong-gun (KR)

(73) Assignee: RSUPPORT CO., LTD., Seoul (KR)

(21) Appl. No.: 13/775,723

(22) Filed: Feb. 25, 2013

(30) Foreign Application Priority Data
Mar. 22, 2012 (KR) 10-2012-0029217

(51) Int. Cl. G06F 3/01

(52) U.S. Cl. CPC G06F 3/01
USPC 455/420

(57) ABSTRACT

A method and apparatus for remotely controlling a mobile terminal using a virtual keypad are disclosed. According to an aspect, there is provided a method in which a mobile terminal is remotely controlled by data received from a computer connected by wire or wirelessly to the mobile terminal, including: at the mobile terminal, operating a keypad application for remote control installed in the mobile terminal if a text input control on an active window of the mobile terminal is activated; and at the mobile terminal, transferring, if text data is received from the computer, the received text data to the keypad application for remote control.

### CLAIM FOR PRIORITY

This application claims priority to Korean Patent Application No. 10-2012-0029217 filed on Mar. 22, 2012 in the Korean Intellectual Property Office (KIPO), the entire contents of which are hereby incorporated by reference.

### BACKGROUND

1. Technical Field

An example embodiment of the present invention relates in general to a method and apparatus for remotely controlling a mobile terminal, and more specifically, to a method and apparatus for remotely controlling a mobile terminal using a virtual keypad.

2. Related Art

Personal computer (PC) remote control is technology for remotely accessing and controlling PCs that are a great distance away or distributed over a large area. The PC remote control enables a user to remotely use his or her PC through the Internet, that is, to remotely use all functions of his or her PC while viewing the screen of another computer connected to the Internet.

Due to its convenience, the PC remote control which has been used to monitor and manage user PCs at businesses has been widely propagated to private users. Accordingly, many private users control their office PCs from home or their home PCs from the office using a remote control tool.

Meanwhile, with the generalized use of the Internet through a mobile terminal such as a smart phone, applications for remotely controlling a smart phone through a PC are being developed. However, in order to remotely control a smart phone with a touch screen using a PC, a virtual keypad should be used, unlike a PC-to-PC remote control solution. However, it is inconvenient to input text requiring a complicated manipulation through a virtual keypad.

### SUMMARY

Accordingly, example embodiments of the present invention are provided to substantially obviate one or more problems due to limitations and disadvantages of the related art.

An example embodiment of the present invention provides a remote control method of a mobile terminal, allowing a user to conveniently input text requiring a complicated manipulation.

Another example embodiment of the present invention also provides a remote control apparatus of a mobile terminal, allowing a user to conveniently input text requiring a complicated manipulation.

In an example embodiment, there is provided a method in which a mobile terminal is remotely controlled by data received from a computer connected by wire or wirelessly to the mobile terminal, including: at the mobile terminal, operating a keypad application for remote control installed in the mobile terminal if a text input control on an active window of the mobile terminal is activated; and at the mobile terminal, transferring, if text data is received from the computer, the received text data to the keypad application for remote control.

In another example embodiment, there is provided a method in which a computer connected by wire or wirelessly to a mobile terminal remotely controls the mobile terminal, including: displaying a remote control window which is a user interface for receiving data for controlling the mobile terminal, on the screen of the computer; and transmitting, if an input of text data through a manipulation of the input unit of the computer is sensed when the remote control window is an active window, the text data to the mobile terminal.

In still another example embodiment, there is provided a mobile terminal in which a keypad application for remote control is installed, wherein the mobile terminal is remotely controlled by a computer connected by wire or wirelessly to the mobile terminal, the keypad application for remote control operates if a text input control on an active window of the mobile terminal is activated, and the keypad application for remote control is configured to transfer, if text data is received from the computer, the text data to the text input control on the active window.

Therefore, according to the method and apparatus for remotely controlling the mobile terminal using the virtual keypad, as described above, by allowing a user to input text data using an input unit such as a keyboard of a computer without displaying a virtual keypad that is basically provided by the OS of the mobile terminal, the user can easily and remotely input text to the mobile terminal. Particularly, inputting text through the keyboard may be useful when a user inputs 2-byte (Unicode) data, such as special characters, Korean, Japanese, Chinese, etc., requiring complicated manipulations and the frequent conversion of virtual keypad images.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view showing a conventional system for remotely controlling a mobile terminal using a virtual keypad;

FIG. 2 is a conceptual view showing a system for remotely controlling a mobile terminal using a transparent keypad, according to an embodiment of the present invention;

FIG. 3 is a flowchart illustrating a method in which a mobile terminal is remotely controlled using a keypad application for remote control, according to an embodiment of the present invention; and

FIG. 4 is a flowchart illustrating a method of remotely controlling a mobile terminal, according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

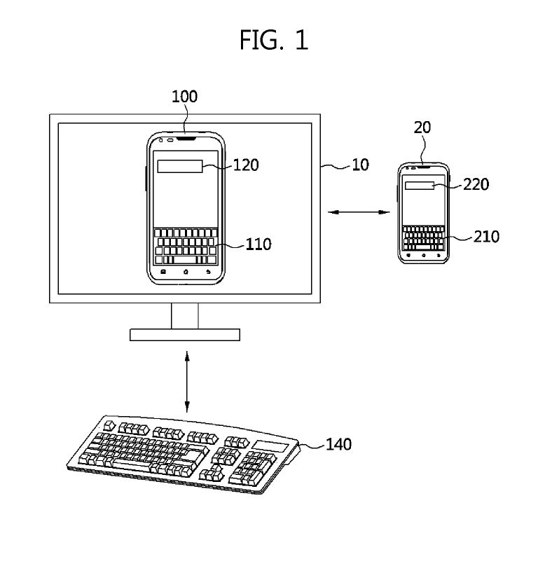

FIG. 1 is a conceptual view showing a conventional system for remotely controlling a mobile terminal 20 using a virtual keypad.

Referring to FIG. 1, according to the conventional system, when a user connects the mobile terminal 20 (for example, a smart phone) to a computer screen 10 to remotely control the screen of the smart phone 20 while viewing the computer screen 10, the user uses a virtual keypad 110 of a remote control window 100 displayed on the computer screen 10 to input text to the smart phone 20, wherein the virtual keypad 110 corresponds to a virtual keypad 210 of the smart phone 20, and the virtual keypad 210 is, for example, configured as a keypad image on a predetermined area of the smart phone 20 to detect a touch on the keypad image as an input from the user.

That is, if a text input control 220 of the smart phone 20 is activated, the virtual keypad 210 is automatically displayed on the screen of the smart phone 20 although the smart phone 20 is in a remotely controlled state. Accordingly, the virtual keypad 210 displayed on the smart phone 20 is displayed on the remote control window 100 of the computer screen 10 that shares the screen of the smart phone 20 so that the smart phone 20 can receive text from the computer by mouse clicking on the virtual keypad 110.

However, the conventional system has the disadvantages of low input speed and low user-friendliness, and a part of the computer screen 10 is covered by the virtual keypad 110. Furthermore, the computer need not receive text using such a virtual keypad 110 since the computer itself has a keyboard.

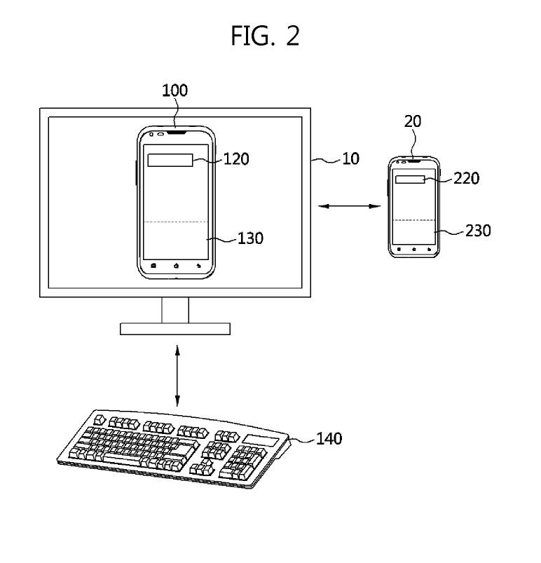

FIG. 2 is a conceptual view showing a system for remotely controlling a mobile terminal 20, according to an embodiment of the present invention.

Referring to FIG. 2, the system for remotely controlling the mobile terminal 20 displays an invisible, transparent keypad 230, instead of a virtual keypad that is automatically displayed on the screen of the mobile terminal 20, when a text input control 220 is activated. That is, instead of executing a virtual keypad function or a virtual keypad application that is basically provided by the OS of the mobile terminal 20, a keypad application for remote control is executed such that no virtual keypad is displayed on the screen.

Accordingly, a key touch function through a virtual keypad is replaced with strokes of the keyboard 140 of a computer that remotely controls the mobile terminal 20. However, a visible virtual keypad or an invisible virtual keypad may be displayed on the computer screen 10 according to a setting. If the virtual keypad of the mobile terminal 20 is displayed as the invisible, transparent keypad 230, the transparent keypad 230 is displayed on a remote control window 130 of the computer screen 10 such that no part of the computer screen 10 is covered by the keypad 230.

Accordingly, in the remote control system according to the present embodiment, a user inputs text to a text input control 120 of the computer screen 10 through manipulations of the keyboard 140 while no virtual keypad is displayed on the computer screen 10, and the input text is transmitted to the mobile terminal 20 to be displayed on the text input control 220.

Hereinafter, a remote control method according to an embodiment of the present invention will be described in more detail.

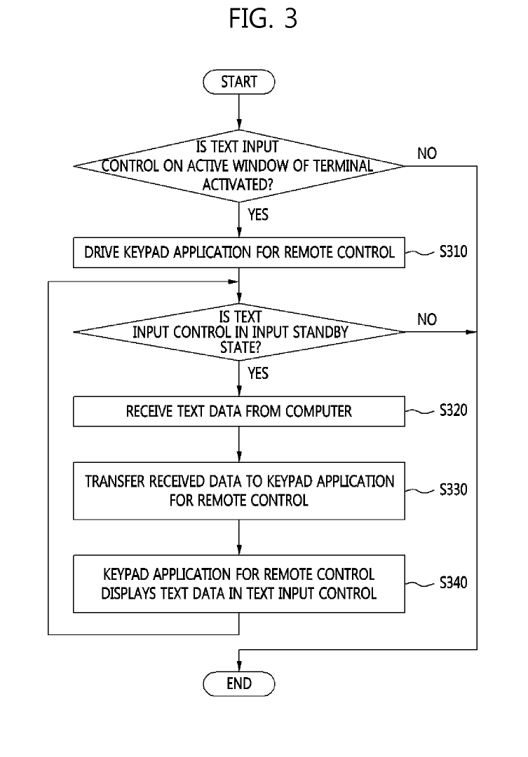

FIG. 3 is a flowchart illustrating a method in which a mobile terminal is remotely controlled using a keypad application for remote control, according to an embodiment of the present invention.

Referring to FIG. 3, the method in which the mobile terminal is remotely controlled using the keypad application for remote control may include operation S310 of driving the keypad application for remote control, operation S320 of receiving text data, operation S330 of transferring the text data, and operation S340 of displaying the text data. Operations S310 through S340 may correspond to a remote control method that is performed by a mobile terminal that is controlled by a computer connected by wire or wirelessly to the mobile terminal. The mobile terminal may be connected to the computer in various methods, such as a wired LAN, a wireless LAN, 3G, Wibro, Bluetooth, infrared communication, a USB connection, etc., and the mobile terminal may be a personal digital assistant (PDA), a smart phone, etc.

The operations S310 through S340 of the method in which the mobile terminal is remotely controlled using the keypad application for remote control will be described in detail with reference to FIG. 3, below.

In operation S310 of driving the keypad application for remote control, if a text input control of the mobile terminal is activated, the keypad application for remote control installed in the mobile terminal is driven.

In the case of a terminal without a physical keypad such as a smart phone, a text input box is provided on the screen of the terminal to allow a user to input or edit data, and in this case, a virtual keypad is automatically displayed as an image on the screen of the terminal. However, the keypad application for remote control may display no virtual keypad although the text input control is activated. That is, if the keypad application for remote control is driven, the keypad application for remote control may disable a virtual keypad function that is basically provided by the OS of the mobile terminal.

In operation S320 of receiving text data, text data is received from a computer (hereinafter, also referred to as a remote control computer) that remotely controls the mobile terminal. Here, the text data may be data input through manipulations of the input unit (for example, a keyboard) of the remote control computer. Particularly, the text data may be text data input through manipulations of the input unit such as a keyboard when the text input control on an active window of the mobile terminal is in an input standby state, for example, when a cursor is positioned in the text input control to wait for an input of text from a user through the mouse or keyboard.

For example, if a user of the remote control computer tries to input text, the remote control computer positions a cursor in the text input control on the remote control window, while displaying no virtual keypad since the keypad application for remote control is being driven on the mobile terminal. Accordingly, if the user inputs text through the keyboard of the computer, the input text, that is, values converted into text according to the stroked specific keys of the keyboard, and the mode (for example, Korean/English, uppercase/lowercase, etc.) of the keyboard are transmitted to the mobile terminal so that the mobile terminal receives the corresponding text data.

In operation S330 of transferring the text data, the text data received in operation S320 is transmitted to the keypad application for remote control.

In operation S430 of displaying the text data, the text data received by the keypad application for remote control is transferred to the text input control so that the text data is displayed on the screen.

As described above, the keypad application for remote control may operate exclusively from a virtual keypad application that is basically provided by the OS of the mobile terminal. That is, if the keypad application for remote control operates, the virtual keypad function of the mobile terminal does not operate so that no virtual keypad is displayed on the screen of the mobile terminal. The keypad application for remote control according to the present embodiment may operate as if a virtual keypad is displayed on the screen even when no keypad image is displayed. That is, if the mobile terminal receives text data from the remote control computer, the mobile terminal transfers the received text data to the text input control and displays the text data on the screen as if keys on a virtual keypad are touched.

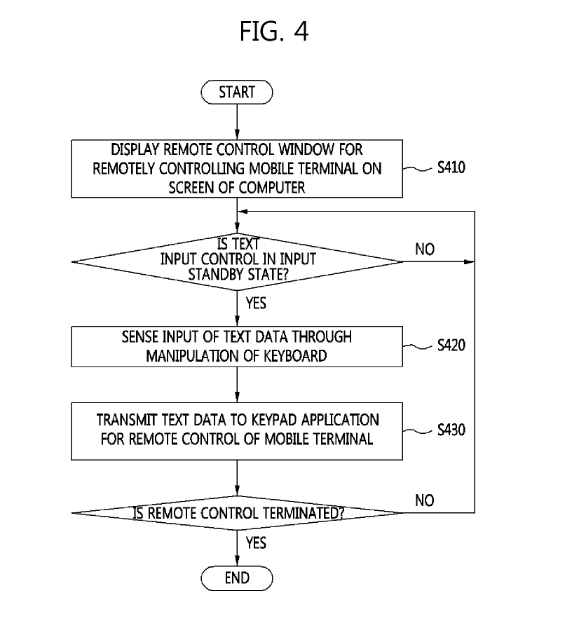

FIG. 4 is a flowchart illustrating a method of remotely controlling a mobile terminal, according to an embodiment of the present invention.

Referring to FIG. 4, the method of remotely controlling the mobile terminal may include operation S410 of displaying a remote control window, operation S420 of sensing an input of text data, and operation S430 of transmitting text data.

The method of remotely controlling the mobile terminal will be described in detail with reference to FIG. 4, below.

In operation S410 of displaying the remote control window, the remote control window which is a user interface for receiving data for controlling the mobile terminal is displayed on the screen of a computer that remotely controls the mobile terminal.

In operation S420 of sensing the input of text data, the input of text data through the input unit of the computer is sensed when the remote control window is an active window. That is, when a text input control on the remote control window is in an input standby state, an input of text data through manipulations of the keyboard of the computer may be sensed.

In operation S430 of transmitting the text data, the text data sensed in operation S420 of sensing the text data is transmitted to the mobile terminal that is remotely controlled. At this time, the text data that is transmitted to the mobile terminal may be transmitted to a keypad application for remote control. Meanwhile, the keypad application for remote control may be configured to transfer the received text data to the text input control on the active window of the mobile terminal.

For example, if the mobile terminal is based on a method of receiving a user input using a virtual keypad image since the mobile terminal has no physical keypad, and the keypad application for remote control is operating in the mobile terminal, no virtual keypad may be displayed on the remote control window even though the mobile terminal is in a text data input mode. In this case, text data input through the keyboard of the computer may be transmitted to the mobile terminal so that the text data is displayed on the text input control.

While the example embodiments of the present invention and their advantages have been described in detail, it should be understood that various changes, substitutions and alterations may be made herein without departing from the scope of the invention.

1. A method in which a mobile terminal is remotely controlled by data received from a computer connected by wire or wirelessly to the mobile terminal, comprising:
at the mobile terminal, operating a keypad application for remote control installed in the mobile terminal if a text input control on an active window of the mobile terminal is activated; and
at the mobile terminal, transferring, if text data is received from the computer, the received text data to the keypad application for remote control.

2. The method of claim 1, wherein the keypad application for remote control is configured to transfer the text data to the text input control on the active window of the mobile ten final.

3. The method of claim 1, wherein the keypad application for remote control operates instead of a virtual keypad application that is basically provided by an OS of the mobile terminal.

4. The method of claim 1, wherein the keypad application for remote control displays no virtual keypad on the screen of the mobile terminal.

5. The method of claim 1, wherein the text data received from the computer is data input through a manipulation of the keyboard of the computer when the text input control on the active window of the mobile terminal is in an input standby state.

6. A method in which a computer connected by wire or wirelessly to a mobile terminal remotely controls the mobile terminal, comprising:
displaying a remote control window which is a user interface for receiving data for controlling the mobile terminal, on the screen of the computer; and
transmitting, if an input of text data through a manipulation of the input unit of the computer is sensed when the remote control window is an active window, the text data to the mobile terminal.

7. The method of claim 6, wherein the transmitting of the text data to the mobile terminal comprises sensing an input of text data through a manipulation of the keyboard of the computer when the text input control on the remote control window is in an input standby state, and transmitting the text data to the mobile terminal.

8. The method of claim 6, wherein the text data input through the manipulation of the input unit of the computer is transferred to a keypad application for remote control of the mobile terminal, and
the keypad application for remote control is configured to transfer the text data to a text input control on an active window of the mobile terminal.

9. The method of claim 8, wherein the keypad application for remote control operates instead of a virtual keypad application that is basically provided by an OS of the mobile terminal

10. A mobile terminal in which a keypad application for remote control is installed, wherein
the mobile terminal is remotely controlled by a computer connected by wire or wirelessly to the mobile terminal,
the keypad application for remote control operates if a text input control on an active window of the mobile terminal is activated, and
the keypad application for remote control is configured to transfer, if text data is received from the computer, the text data to the text input control on the active window.

11. The mobile terminal of claim 10, wherein the text data received from the computer is data input through a manipulation of the keyboard of the computer when the text input control on the active window of the mobile terminal is in an input standby state.

12. The mobile terminal of claim 10 or 11, wherein the keypad application for remote control operates instead of a virtual keypad application that is basically provided by an OS of the mobile terminal.

13. The mobile terminal of claim 10 or 11, wherein the keypad application for remote control displays no virtual keypad on the screen of the mobile terminal.
